(19) United States
(12) Patent Application Publication
(10) Pub. No.: US 2004/0114373 A1
(43) Pub. Date: Jun. 17, 2004

(54) Lighting structure

(76) Inventor: Jack Lin, Taipei (TW)

Correspondence Address: JACK LIN, 4F, NO. 116, WEN-LIN N. RD., TAIPEI, TW

(21) Appl. No.: 10/328,554

(22) Filed: Dec. 16, 2002

(51) Int. Cl. F21V 11/00

(52) U.S. Cl. 362/352; 362/351; 362/319; 362/323; 362/186; 362/198

(57) ABSTRACT

A lighting structure includes a supporting member, a lampshade and an adjusting mechanism. The lampshade is connected on a top of the supporting member. The adjusting mechanism is arranged inside the lampshade, and respectively includes a guide track formed in the lampshade, two telescopic adjusting rods with an adjustable length, a flat column and a rail. The flat column and the rail are slidably arranged in the guide track, the length of the lampshade is thereby adjustable by means of the adjusting rods to be adequately positioned over an area to be illuminated.

### BACKGROUND OF THE INVENTION

1. Field of the Invention

The invention relates to a lighting structure. More particularly, the invention provides a lighting structure having a lampshade that is foldable and lengthwise adjustable.

2. Description of the Related Art

FIG. 1 is a perspective view of a conventional foldable lighting structure. A foldable lighting structure 1 known in the art includes a lampshade 10 and a base 11, which are folded toward each other when the lighting structure is not used, and unfolded when the lighting structure is used. An advantage of the, above foldable lighting structure is it is relatively compact.

However, the length of the lampshade 10 is limited to that of the base 11, and therefore the illuminated area of a light source 12 is limited. Particularly, when a user needs the lighting structure 1 to illuminate a large area such as a newspaper or a blueprint, the light is easily obstructed by the base 11.

As described above, the conventional foldable lighting therefore has a limited illumination range.

### SUMMARY OF THE INVENTION

It is an object of the invention to provide a lighting structure having a lampshade with an adjustable length, which is convenient to fold and position the lampshade over an area to be illuminated.

In order to achieve the above and other objectives, a lighting structure with a lengthwise adjustable lampshade is provided. The lighting structure includes a supporting member, a lampshade and an adjusting mechanism. The supporting member includes a base and a supporting body. The lampshade includes a first sub-assembly, a second sub-assembly and a cover. The adjusting mechanism includes a guide track, a flat column, a rail and two telescopic adjusting rods. The adjusting rods are secured between the first and second sub-assemblies. The flat column and the rail are secured onto the first sub-assembly and are able to slide in the guide track. Thereby, the length of the lampshade is adjustable to adequately position the lampshade over an area to be illuminated.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a conventional foldable lighting structure;

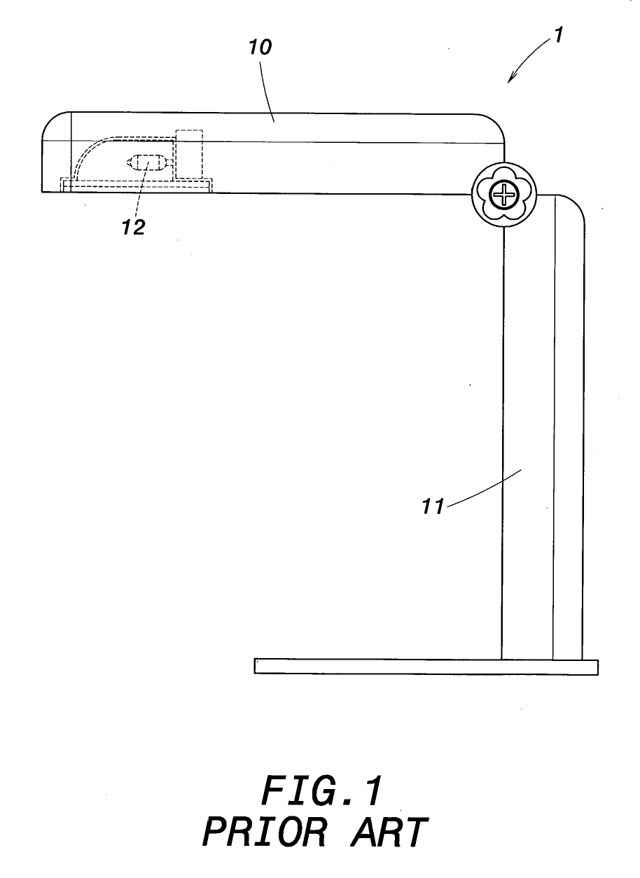

FIG. 2 is an exploded view of a lighting structure according to one embodiment of the invention;

FIG. 3 is a perspective view of a lighting structure according to one embodiment of the invention;

FIG. 4 is a cross-sectional view of a lighting structure according to one embodiment of the invention;

FIG. 5 is a cross-sectional view of a lighting structure when the lampshade is not elongated according to one embodiment of the invention;

FIG. 6 is a perspective view of a lighting structure when the lampshade is not elongated according to one embodiment of the invention; and

FIG. 7 is a cross-sectional view illustrating the operation of a lighting structure according to one embodiment of the invention.

### DETAILED DESCRIPTION OF THE EMBODIMENTS

Wherever possible in the following description, like reference numerals will refer to like elements and parts unless otherwise illustrated.

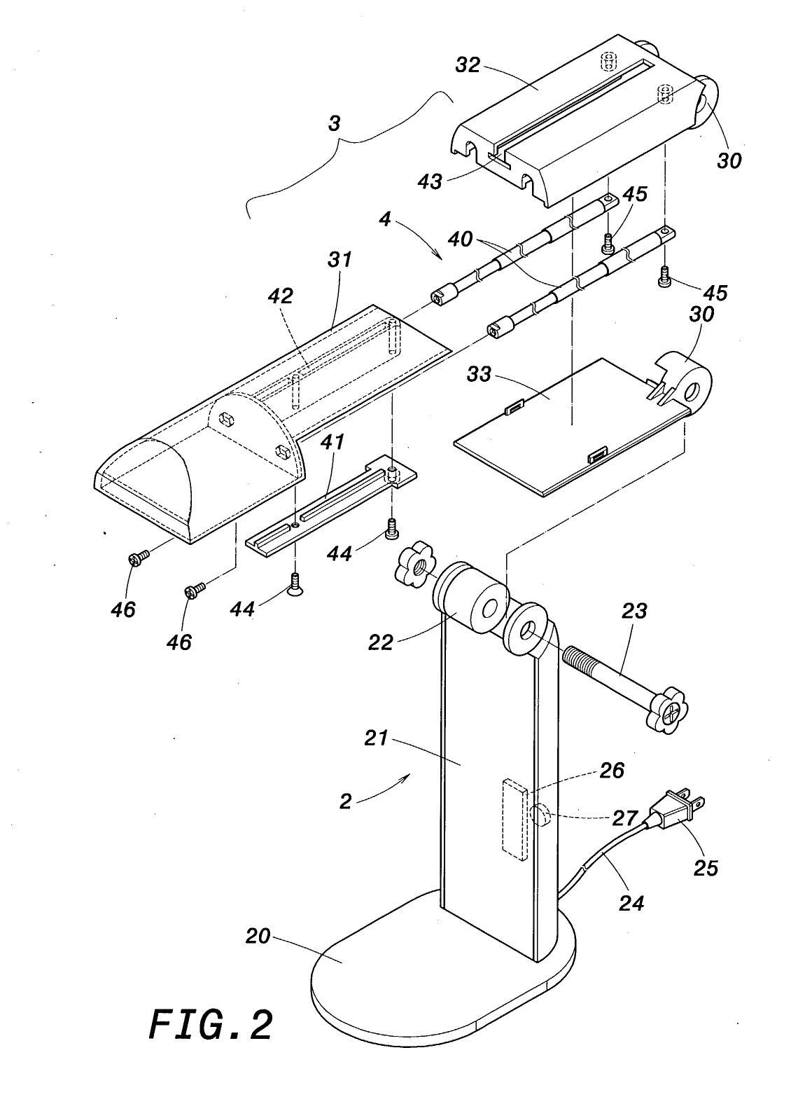

Referring to FIG. 2, a lighting structure of the invention includes a supporting member 2, a lampshade 3, and an adjusting mechanism 4.

The supporting member 2 includes a base 20, a supporting body 21, a first hinge part 22, and a bolt 23. The supporting body 21 is vertically connected on the base 20. The first hinge part 22 is mounted on a top of the supporting body 21. The supporting body 21 is externally connected with a wire 24 and a plug 25, and an electrical junction box 26 and a switch pin 27 are mounted inside the supporting body 21, thereby safely supplying electric power to the lighting structure.

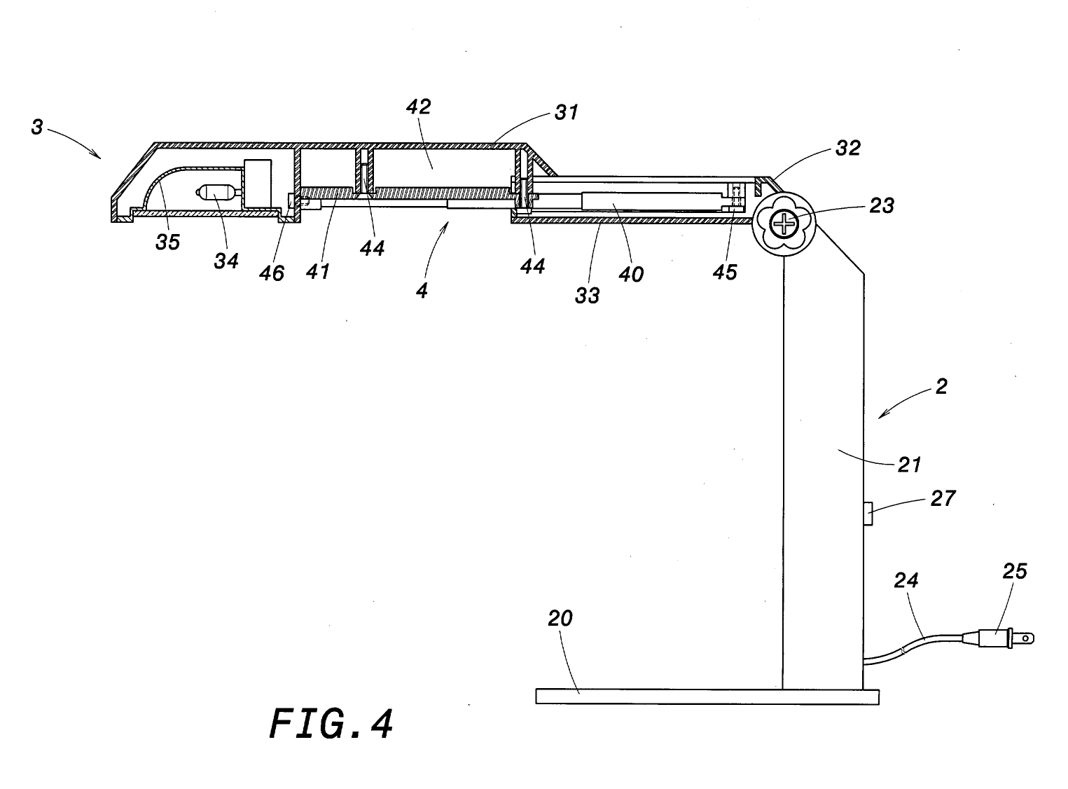

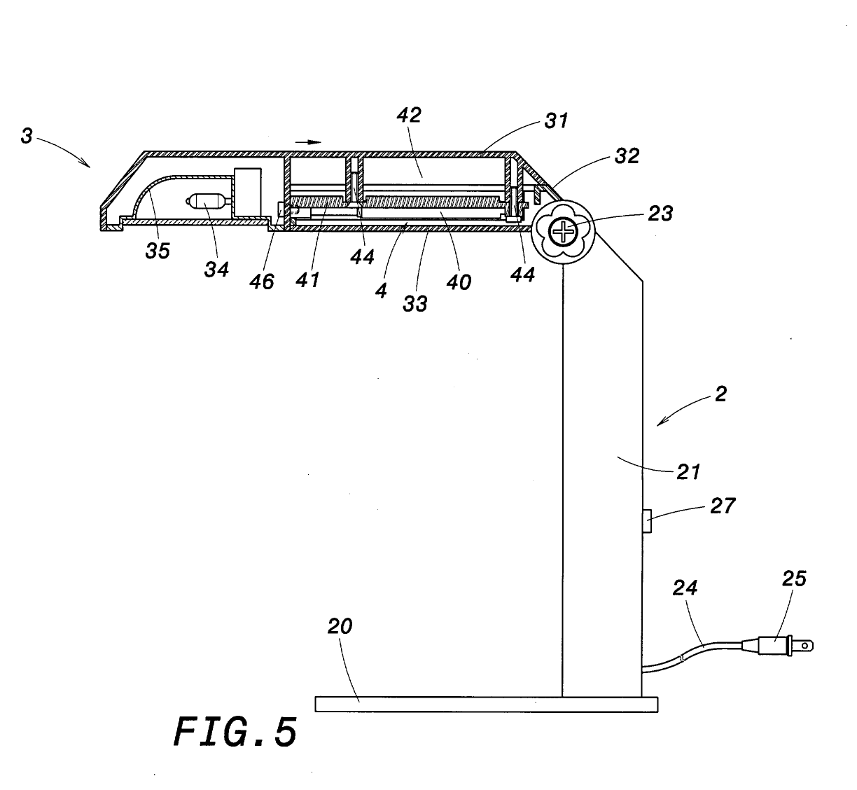

As illustrated in FIG. 4 and FIG. 5, the lampshade 3 includes a second hinge part 30, a first sub-assembly 31, a second sub-assembly 32, a cover-33, a light source 34 and a reflective mask 35. The second hinge part 30 is mounted at corresponding edges of the second sub-assembly 32 and the cover 33. The second hinge part 30 is aligned with the first hinge part 22 for receiving the bolt 23 to pivotally connect the lampshade 3 to the supporting member 2. The light source 34 and the reflective mask 35 are mounted at a side of the first sub-assembly 31 far away from the second hinge part 30.

The light source 34 is, for example, a bulb or a luminescent tube.

The adjusting mechanism 4 includes two adjusting rods 40, a rail 41, a flat column 42 and a guide track 43 having a T-shaped cross-section. Each of the adjusting rods consists of a plurality of sub-rods with different diameters that telescopically slide into each other. Each sub-rod has a protuberance on one end portion and a recess on an opposite end portion. By the engagement of the protuberance of one sub-rod with the recess of an adjacent sub-rod, the total length of the adjusting mechanism 4 can be adjusted. One end of each adjusting rod 40 is screwed onto the second sub-assembly 32 via a screw 45 and the other end of each adjusting rod 40 is screwed onto the first sub-assembly 31 via a screw 46. The rail 41 is vertically screwed onto the flat column 42 via a screw 44. In one embodiment of the invention, the flat column 42 is, for example, integrally formed with the first sub-assembly 31. The rail 41 and the flat column 42 are arranged on the guide track 43 formed on a top of the second sub-assembly 32. The cover 33 snaps on a bottom of the second sub-assembly 32. Thereby, the adjusting mechanism 4 is secured between the first sub-assembly 30 and the second sub-assembly 31.

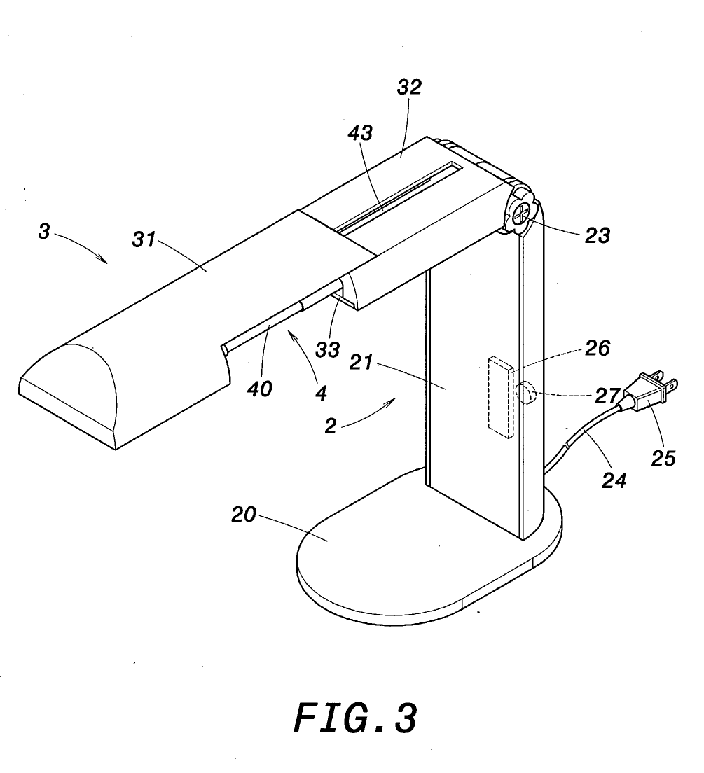

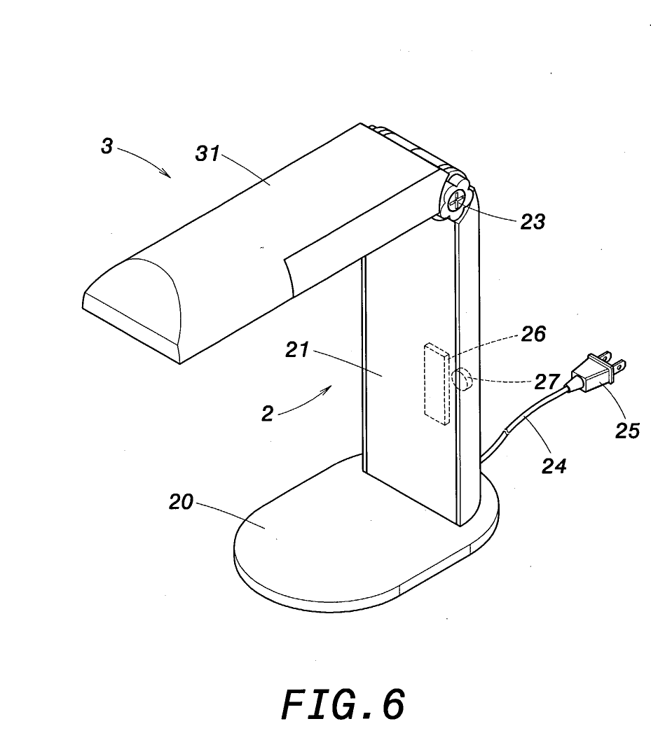

Referring to FIG. 2, FIG. 3 and FIG. 6, the second hinge part 30 is aligned with and pivotally connected to the first hinge part 22 via the bolt 23 so that the lampshade 3 is thereby pivotally connected to the supporting member 2. One end of each adjusting rod 40 is screwed onto the second sub-assembly 32, while an opposite end is screwed onto the first sub-assembly 31. The flat column 42 is mounted on the first sub-assembly corresponding to the guide track 43. The rail 41 is secured onto the flat column 42 in a manner that both rail 41 and flat column 42 are able to fit into the guide track 43. Therefore, the adjusting mechanism 4 is secured between the first sub-assembly 30 and the second sub-assembly 31 to accomplish the lighting structure of the invention.

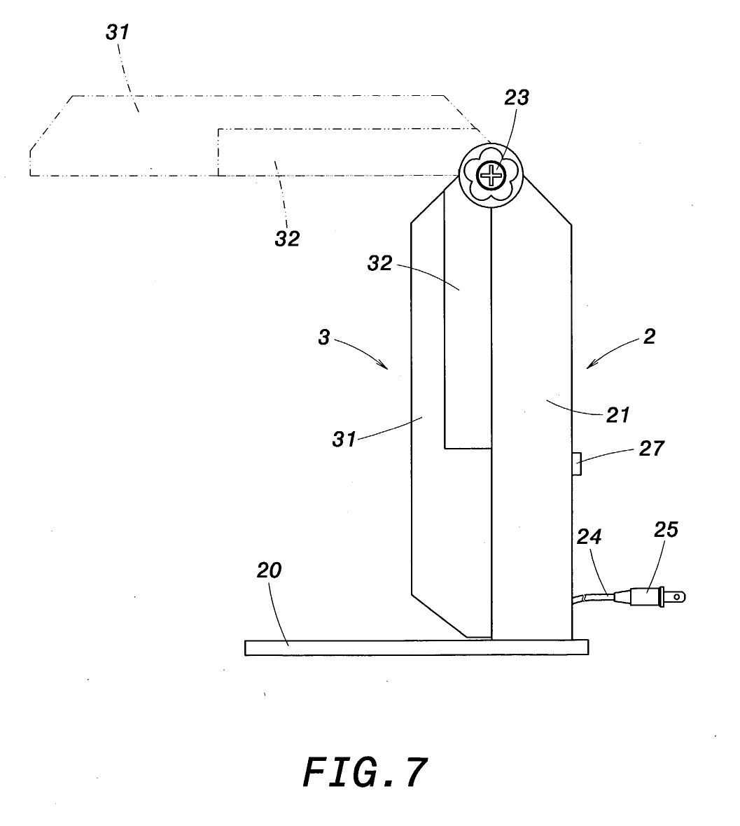

Referring to FIG. 3 to FIG. 7, when the adjusting rod 40 has a minimum length, the rail 41 and the flat column 42 are completely and slidably received in the T-shaped guide track 43, so that the lampshade 3 and the supporting member 2 can be folded toward each other (see FIG. 7). When the lighting structure is to be used, the first sub-assembly 31 is pulled up, and then the adjusting rods 40, the rail 41 and the flat column 42 are deployed to switch on the light source 34 and properly position the reflective mask 35.

As described above, the invention therefore has the following advantages. By means of the adjusting mechanism, the lampshade of the invention has an adjustable length. It is therefore convenient to fold the lampshade for storage and deploy the lampshade for illuminating a desired area.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A lighting structure with a lengthwise adjustable lampshade, the lighting structure comprising:
a supporting member, including a base and a supporting body;
a lampshade, including a first sub-assembly, a second sub-assembly and a cover, wherein the second, sub-assembly is respectively assembled with the second sub-assembly and the cover; and
an adjusting mechanism, mounted between the first sub-assembly and the second sub-assembly, the adjusting mechanism comprising:
a guide track, formed on a top of the second sub-assembly;
two adjusting rods, a first end of each adjusting rod being screwed onto the first sub-assembly and an opposite second end of each adjusting rod being screwed onto the second sub-assembly;
a flat column, mounted on the first sub-assembly correspondingly to the guide track; and
a rail, secured onto the flat column in a manner that both rail and flat column are able to fit into the guide track;
thereby via the slidable mount of the flat column and the rail in the guide track, the length of the lampshade is adjustable to position the lampshade over an area to be illuminated.

2. The lighting structure of claim 1, wherein a first hinge part is further mounted on a top of the supporting body, and a second hinge part is mounted at an edge of the second sub-assembly, the second hinge part being aligned with the first hinge part for receiving a bolt to thereby pivotally connect the lampshade to the supporting member.

3. The lighting structure of claim 1, wherein a light source and a reflective mask are mounted at a side of the first sub-assembly.

4. The lighting structure of claim 3, wherein the light source is a bulb or a luminescent tube.

5. The lighting structures of claim 1, wherein each of the adjusting rods comprises of a plurality of sub-rods with different diameters that telescopically slide into each other, each sub-rod having a protuberance on one end portion and a recess on an opposite end portion, by engagement of one protuberance of one sub-rod with one corresponding recess of an adjacent sub-rod, the total length of the adjusting mechanism is thereby adjustable.

6. The lighting structure of claim 1, wherein the rail is vertically screwed onto the flat column integrally formed with the first sub-assembly in the manner that the rail and the flat column are able to fit into the guide track, the cover snapping on a bottom of the second sub-assembly, thereby the adjusting mechanism is mounted between the first sub-assembly and the second sub-assembly.
